(19) United States
(12) Patent Application Publication
(10) Pub. No.: US 2015/0372322 A1
(43) Pub. Date: Dec. 24, 2015

(54) STRUCTURE FOR SECURING HYDROGEN TANK IN FUEL-CELL-TYPE INDUSTRIAL VEHICLE AND FUEL CELL UNIT

(71) Applicant: KABUSHIKI KAISHA TOYOTA JIDOSHOKKI, Kariya-shi, Aichi (JP)

(72) Inventors: Yusuke SHIMOYANA, Kariya-shi (JP); Hiroshi ITO, Kariya-shi (JP)

(73) Assignee: KABUSHIKI KAISHA TOYOTA JIDOSHOKKI, Kariya-shi, Aichi-ken (JP)

(21) Appl. No.: 14/765,669

(22) PCT Filed: Jan. 29, 2014
(86) PCT No.: PCT/JP2014/051925

§ 371 Date: Aug. 4, 2015

(30) Foreign Application Priority Data
Feb. 6, 2013 (JP) 2013-021163

(51) Int. Cl. H01M 8/02; B66F 9/075; H01M 8/04

(52) U.S. Cl. CPC H01M 8/0273; H01M 8/04201; B66F 9/07518; H01M 2250/20

(57) ABSTRACT

Structure for securing hydrogen tank in fuel-cell-type industrial vehicle, wherein said hydrogen tank is characterized in that: a fuel cell unit accommodating a fuel cell is installed in an accommodation compartment for accommodating a battery, the accommodation compartment being provided to a vehicle body; a weight member for weight adjustment and a cross-sectionally cylindrical hydrogen tank are accommodated inside the fuel cell unit; a cross-sectionally-arcuate tank supporting surface that imitates the outer circumferential surface of the hydrogen tank is formed on the top surface of the weight member; and the hydrogen tank is supported on the tank supporting surface and secured by a fixing band provided around the circumferential direction of the outer circumferential surface of the hydrogen tank.

### TECHNICAL FIELD

The present invention relates to a hydrogen tank fixing structure for a fuel cell industrial vehicle and to a fuel cell unit.

### BACKGROUND ART

Fuel cells have now become popular clean energy sources. Industrial vehicles that use fuel cells, which generate power, as drive sources have been proposed.

Forklifts, which are industrial vehicles, include battery forklifts. A battery forklift includes a battery compartment that accommodates a battery. The battery forklift uses the battery in the battery compartment as a drive source when driven and when performing lifting operations.

A recent forklift includes a fuel cell unit that can be accommodated in a battery compartment. The fuel cell unit is accommodated in the battery compartment instead of a battery. The fuel cell forklift uses the fuel cell as a drive source when driven and when performing lifting operations.

When a fuel cell unit is used instead of a battery, the base of a battery forklift can be used for a fuel cell forklift.

Such a fuel cell forklift replaces a battery with a fuel cell unit and is referred to as a “battery replacement fuel cell forklift.”

The base of such a fuel cell forklift uses structures other than that for a power supply source (battery) of a battery forklift.

When the fuel cell uses hydrogen as fuel, a hydrogen tank filled with hydrogen needs to be mounted on the fuel cell industrial vehicle.

In a battery replacement fuel cell forklift, the hydrogen tank is accommodated in a fuel cell unit.

Japanese Laid-Open Patent Publication No. 2011-88550 discloses a vehicle gas tank supporting structure as a prior art example of a tank fixing structure for fixing a fuel cell hydrogen tank to a vehicle.

The vehicle gas tank supporting structure includes a sub-frame that accommodates a gas tank with the axial direction of the gas tank conforming to the widthwise direction of the vehicle body.

The sub-frame includes a sub-frame cross member. The sub-frame cross member, which extends in the vehicle widthwise direction, fixes the front side of the gas tank in the vehicle widthwise direction.

The sub-frame cross member is fixed to a vehicle body cross member that forms a vehicle frame.

The vehicle gas tank supporting structure holds the gas tank in a favorable manner and allows a small cross-sectional area to be set for the frame.

### PRIOR ART DOCUMENT

### Patent Document

Patent Document 1: Japanese Laid-Open Patent Publication No. 2011-88550

### SUMMARY OF THE INVENTION

### Problems that the Invention is to Solve

However, the vehicle gas tank supporting structure disclosed in Japanese Laid-Open Patent Publication No. 2011-88550 merely employs a structure that uses a band to fix the gas tank to the vehicle frame of a passenger vehicle.

A battery replacement fuel cell industrial vehicle requires a means for protecting the hydrogen tank from impacts in a fuel cell unit, weight adjustment of the fuel cell unit, and effective use of the space in the fuel cell unit.

The vehicle gas tank supporting structure disclosed in Japanese Laid-Open Patent Publication No. 2011-88550 cannot provide a means for protecting the hydrogen tank from impacts in a fuel cell unit, cannot adjust the weight of the fuel cell unit, and does not allow for effective use of the space in the fuel cell unit.

It is an object of the present invention to provide a hydrogen tank fixing structure for a fuel cell industrial vehicle that is capable of improving the impact resistance of a hydrogen tank in a fuel cell unit, adjusting the weight of the fuel cell unit, and effectively using the space in the fuel cell unit.

### Means for Solving the Problem

According to one aspect of the present invention, a fuel cell unit that accommodates a fuel cell is accommodated in a battery accommodation compartment arranged in a vehicle body. A weight member for weight adjustment and a hydrogen tank including a tubular cross-section are accommodated in the fuel cell unit. An upper surface of the weight member forms a tank supporting surface that includes an arcuate cross-section and conforms to an outer circumferential surface of the hydrogen tank. The hydrogen tank is supported by the tank supporting surface and fixed by a fixing band extending in a circumferential direction of the outer circumferential surface of the hydrogen tank.

In the present invention, the hydrogen tank is supported by the tank supporting surface of the weight member in the fuel cell unit and fixed by the fixing band.

Thus, since the hydrogen tank is supported by the tank supporting surface and fixed by the fixing band, the impact resistance of the hydrogen tank in the fuel cell unit is improved.

The weight of the fuel cell unit can be adjusted since the weight member is arranged in the fuel cell unit. Further, the space in the fuel cell unit can be effectively used since the upper surface of the weight member forms the tank supporting surface including an arcuate cross-section.

In one aspect, in the above hydrogen tank fixing structure for a fuel cell industrial vehicle, the tank supporting surface is formed to conform to the outer circumferential surface of the hydrogen tank when the hydrogen tank expands.

In this case, the entire tank supporting surface supports the outer circumferential surface of the hydrogen tank. Thus, the concentration of load is avoided on the outer circumferential surface of the hydrogen tank. This limits deformation of the hydrogen tank.

In one aspect, in the above hydrogen tank fixing structure for a fuel cell industrial vehicle, the tank supporting surface is set so that a radial direction of the hydrogen tank conforms to a front-to-rear direction of the vehicle body. The fuel cell unit includes a wall member arranged proximal to one end of the tank supporting surface in the weight member. The other end of the tank supporting surface has an end height set from a deepest point, which is deepest in the tank supporting surface, to the other end of the tank supporting surface. The end height is set so that when external force in the front-to-rear direction received by the hydrogen tank is less than or equal to a predetermined value, the end height cooperates with a band holding force of the fixing band to avoid a situation in which the hydrogen tank that receives the external force is separated from the tank supporting surface.

In this case, the hydrogen tank is able to withstand external force in cooperation with the fixing force of the fixing band even when receiving external force in the front-to-rear direction that is less than or equal to a predetermined value. Thus, the hydrogen tank is not separated from the tank supporting surface even when receiving the external force.

In one aspect, in the above hydrogen tank fixing structure for a fuel cell industrial vehicle, the fixing band includes a weight side end, which is fixed to the other end of the tank supporting surface in the weight member, and a wall side end, which is fixed to the wall member. The weight side end or the wall side end is removable.

In this case, the fixing band is fixed between the other end of the tank supporting surface and the wall member. This shortens the fixing band.

Further, even when external force that separates the hydrogen tank toward the wall member acts on the hydrogen tank, the wall member limits separation of the hydrogen tank. Thus, the hydrogen tank is not separated from the tank supporting surface.

According to another aspect of the present invention, in a hydrogen tank fixing structure for fixing a hydrogen tank including a tubular cross-section for a fuel cell industrial vehicle, a vehicle body of the fuel cell industrial vehicle includes an accommodation compartment for a battery. The accommodation compartment receives a fuel cell unit that accommodates a fuel cell and the hydrogen tank. The hydrogen tank fixing structure includes a weight member for weight adjustment accommodated in the fuel cell unit and a tank supporting surface including an arcuate cross-section and formed by an upper surface of the weight member in conformance with an outer circumferential surface of the hydrogen tank. The tank supporting surface supports the hydrogen tank. The hydrogen tank fixing structure also includes a fixing band extended in a circumferential direction of the outer circumferential surface of the hydrogen tank. The hydrogen tank is fixed by the fixing band.

According to a further aspect of the present invention, in a fuel cell unit including a hydrogen tank fixing structure for a fuel cell industrial vehicle, the fuel cell unit is accommodated in a battery accommodation compartment arranged in a vehicle body of the fuel cell industrial vehicle. The fuel cell unit includes an internally accommodated hydrogen tank including a tubular cross-section, an internally accommodated fuel cell and an internally accommodated weight member for weight adjustment, a tank supporting surface including an arcuate cross-section and formed by an upper surface of the weight member in conformance with an outer circumferential surface of the hydrogen tank. The tank supporting surface supports the hydrogen tank. The fuel cell unit also includes a fixing band extended in a circumferential direction of the outer circumferential surface of the hydrogen tank. The hydrogen tank is fixed by the fixing band.

Other aspects and advantages of the present invention will become apparent from the following description, taken in conjunction with the accompanying drawings, illustrating by way of example the principles of the invention.

### BRIEF DESCRIPTION OF THE DRAWINGS

The features of this disclosure that are considered to be novel are apparent from, in particular, the appended claims. The invention, together with objects and advantages thereof, may best be understood by reference to the following description of the presently preferred embodiments together with the accompanying drawings in which:

FIG. 1 is a side view of a forklift according to one embodiment of the present invention;

FIG. 2 is a plan view showing a fuel cell unit;

FIG. 3A is a front view showing the fuel cell unit, and FIG. 3B is a side view showing the fuel cell unit;

FIG. 4 is a cross-sectional view taken along line A-A in FIG. 2; and

FIG. 5 is a diagram showing the relationship of an external force and a band holding force that act on a hydrogen tank.

### EMBODIMENTS OF THE INVENTION

A hydrogen tank fixing structure for a fuel cell industrial vehicle fuel cell unit according to one embodiment of the present invention will now be described with reference to the drawings.

The present embodiment is an example of applying the hydrogen tank fixing structure to a fuel-cell forklift that serves as a fuel cell industrial vehicle.

The frame of reference for the “front-to-rear,” the “sideward,” and the “vertical” directions is defined as the state when the operator of a fuel cell forklift sits on the seat in the cabin and faces toward the front of the fuel cell fork lift.

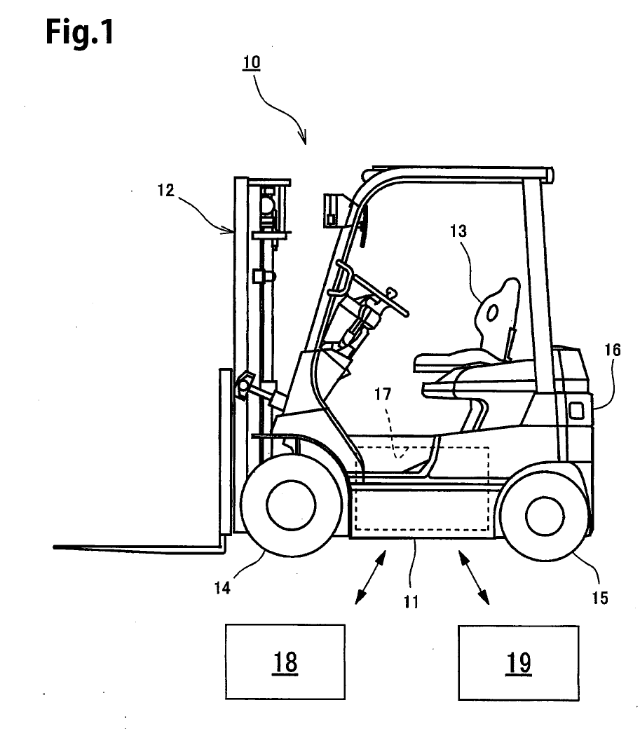

As shown in FIG. 1, a fuel cell forklift (hereinafter referred to as the “forklift”) 10, which serves as a fuel cell industrial vehicle, includes a lifting device 12. The lifting device 12 is arranged at the front of a vehicle body 11.

A cabin 13 is arranged near the middle of the vehicle body 11.

Drive wheels 14, which serve as front wheels, are arranged at the front of the vehicle body 11. Steered wheels 15, which serve as rear wheels, are arranged at the rear of the vehicle body 11.

A counterweight 16 is arranged at the rear of the vehicle body 11. The counterweight 16 is used to adjust the vehicle weight and balance the weight of the vehicle body 11.

The forklift 10 of the present embodiment includes a driving motor (not shown), which is mounted on the vehicle body 11. The driving motor (not shown) is driven by electric power.

An accommodation compartment 17, which accommodates a fuel cell unit 19, is arranged below the cabin 13 in the vehicle body 11. The fuel cell unit 19 is a unitized fuel cell system.

The forklift 10 of the present embodiment is a battery replacement forklift. The forklift 10 accommodates the fuel cell unit 19 in the accommodation compartment 17, which is for a battery forklift that uses a lead battery as a power supplying source, instead of a battery case 18 for a lead battery including many battery cells.

The fuel cell unit 19 of the present embodiment is compatible with the battery case 18.

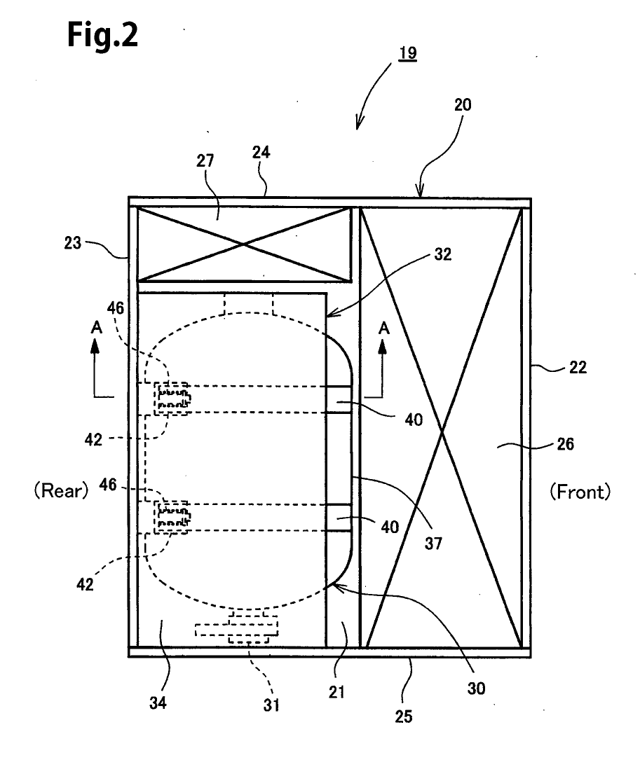

As shown in FIG. 2, the fuel cell unit 19 of the present embodiment includes a box-shaped unit case 20.

The unit case 20 includes a bottom plate 21, wall members 22 and 23, wall members 24 and 25, and a top plate (not shown). The wall members 22 and 23 are arranged at the sides of the bottom plate 21 in the front-to-rear direction. The wall members 24 and 25 are arranged at the left and right sides of the bottom plate 21 in the widthwise direction of the vehicle.

The fuel cell system is accommodated in the unit case 20.

The fuel cell system includes a fuel cell that generates power through an electrochemical reaction of oxidant gas and fuel gas.

The fuel cell has a stacked structure that stacks a plurality of cells, which generate power when supplied with oxidant gas and fuel gas.

The fuel cell generates power through an electrochemical reaction of hydrogen and oxygen when supplied with fuel gas, which contains hydrogen, and oxidant gas, which contains oxygen.

The direct-current power obtained in the fuel cell is decreased in voltage by a DC/DC converter (not shown). Then, the power is supplied to a drive source or the like of the forklift 10. Further, surplus power is used to charge a power storage device (not shown) such as a capacitor or a rechargeable battery.

The fuel cell system includes devices such as a hydrogen tank 30, a power storage device, and a controller, in addition to the fuel cell. These devices are accommodated in the unit case 20.

In the present embodiment, as shown in FIG. 2, the devices of the fuel cell system except for the hydrogen tank 30 form a first device group 26 and a second device group 27.

The first device group 26 is arranged at the front side of the unit case 20. The first device group 26 is formed by devices such as a fuel cell, a radiator that cools the fuel cell, and an air pump that supplies oxidant gas.

The second device group 27 is arranged at the rear side of the first device group 26 together with the hydrogen tank 30. The second device group 27 is mainly formed by the power storage device that stores power.

The hydrogen tank 30 is a tank having a tubular cross-section and is filled with high-pressure hydrogen. A tank valve 31 is arranged at one end of the hydrogen tank 30 in the axial direction.

A pipe (not shown) connected to the fuel cell is arranged in the tank valve 31. Hydrogen gas is supplied from the hydrogen tank 30 to the fuel cell through the pipe.

The hydrogen tank 30 is more expanded when fully filled with hydrogen gas than when not fully filled with hydrogen gas. For example, the tank diameter is increased by approximately several percent when expanded.

In the present embodiment, a weight member 32 that adjusts the weight is accommodated in the unit case 20.

The weight member 32 is a member that adjusts the weight of the fuel cell unit 19.

In the battery replacement forklift 10, the battery case 18 needs to be equal in weight to the fuel cell unit 19 to balance the weight of the vehicle body 11 when accommodating the fuel cell unit 19. The battery case 18 is heavier than the fuel cell unit 19. Thus, the weight member 32 is arranged in the fuel cell unit 19 so that the battery case 18 has the same weight as the fuel cell unit 19.

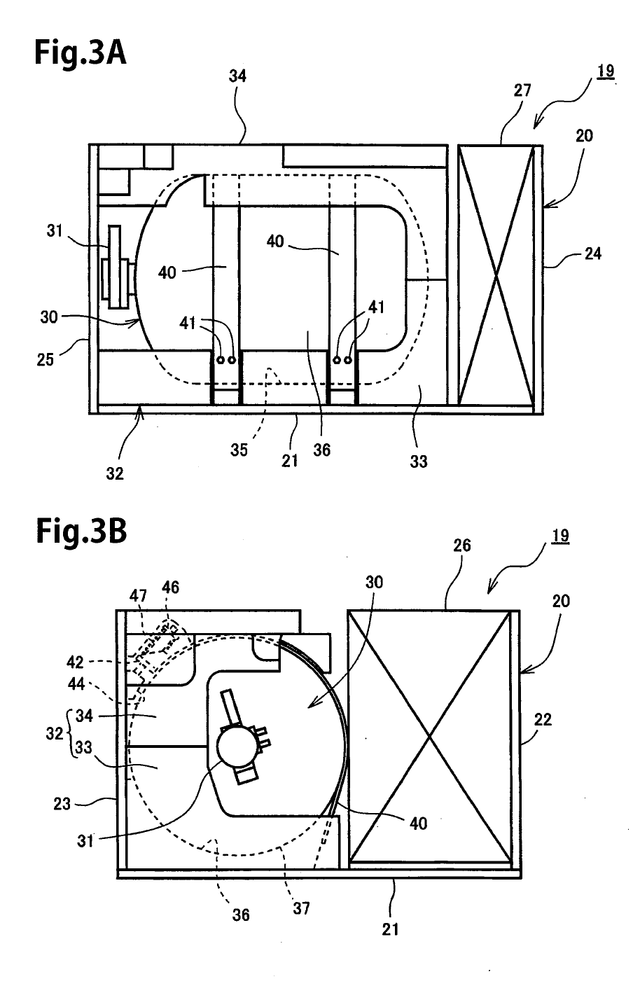

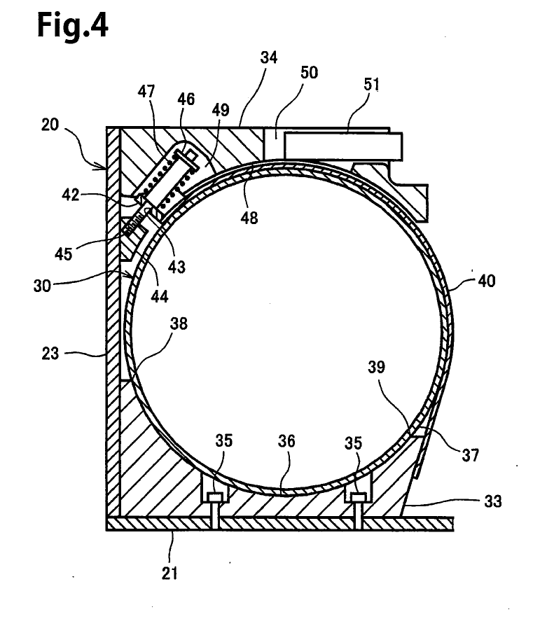

As shown in FIGS. 3A, 3B, and 4, the weight member 32 of the present embodiment includes a lower weight 33 and an upper weight 34.

As shown in FIG. 4, the lower weight 33 is fixed to the bottom plate 21 by bolts 35, and the rear surface of the lower weight 33 is arranged in the proximity of the rear wall member 23.

The upper surface of the lower weight 33 defines a tank supporting surface 36, which includes an arcuate cross-section and supports the hydrogen tank 30.

As shown in FIG. 4, the tank supporting surface 36 is formed to conform to an outer circumferential surface 37 of the hydrogen tank 30 when the hydrogen tank 30 is filled with hydrogen gas and expanded.

Thus, the outer circumferential surface 37 of the hydrogen tank 30 when expanded does not receive locally concentrated loads from the tank supporting surface 36. Further, the outer circumferential surface 37 does not easily receive concentrated loads when not expanded.

The circumferential length of the tank supporting surface 36 of the present embodiment is set to be approximately one-third of that of the outer circumferential surface 37 of the hydrogen tank 30.

A rear end 38 of the tank supporting surface 36 corresponds to one end of the tank supporting surface 36, and a front end 39 of the tank supporting surface 36 corresponds to the other end of the tank supporting surface 36.

The tank supporting surface 36 is set so that the radial direction of the hydrogen tank 30 conforms to the front-to-rear direction of the vehicle body 11. Thus, the axial direction of the hydrogen tank 30 conforms to the sideward direction (widthwise direction) of the vehicle body.

The lower weight 33 functions as a weight used for weight adjustment and functions to protect the lower portion of the hydrogen tank 30.

Metal fixing bands 40 are extended along the outer circumferential surface 37 of the hydrogen tank 30, which is arranged on the tank supporting surface 36. A first end (front end) of the fixing band 40 is fixed by bolts 41 to the front surface of the lower weight 33.

The present embodiment includes two fixing bands 40.

A second end (rear end) of the fixing band 40 includes a connector 42, which includes a through hole 43.

The first end of the fixing band 40 corresponds to a weight side end and the second end of the fixing band 40 corresponds to a wall side end.

Fixing members 44, which are used to fix the connectors 42, are fixed to the front surface of the rear wall member 23. Each fixing member 44 includes a threaded hole 45.

The connector 42 is connected to the fixing member 44 by inserting a bolt 46 through the through hole 43 of the connector 42 and fastening the bolt 46 to the threaded hole 45 of the fixing member 44.

The bolt 46 includes a coil spring 47. When the connector 42 is connected to the fixing member 44, a spring load of the coil spring 47 applies a constant holding force of the fixing band 40 to the hydrogen tank 30 regardless of whether or not the hydrogen tank 30 is expanded.

The connector 42 can be unfastened by removing the bolts 41. The connector 42 of the fixing band 40 is removable from the fixing member 44.

The upper weight 34 is arranged above the hydrogen tank 30. The upper weight 34 is joined with the lower weight 33 by bolts (not shown).

The upper weight 34 includes a lower surface 48. The lower surface 48 is formed so that the lower surface 48 does not interfere with the outer circumferential surface 37 of the hydrogen tank 30 when the upper weight 34 is joined with the lower weight 33.

The upper weight 34 includes a cavity 49, which is arranged so that the upper weight 34 does not interfere with the connector 42 and the bolt 46.

The upper weight 34 includes a cavity 50 that is able to receive an electronic component 51 or the like, which differs from the first device group 26 and the second device group 27.

The upper weight 34 functions as a weight used for weight adjustment and functions to protect the upper portion of the hydrogen tank 30.

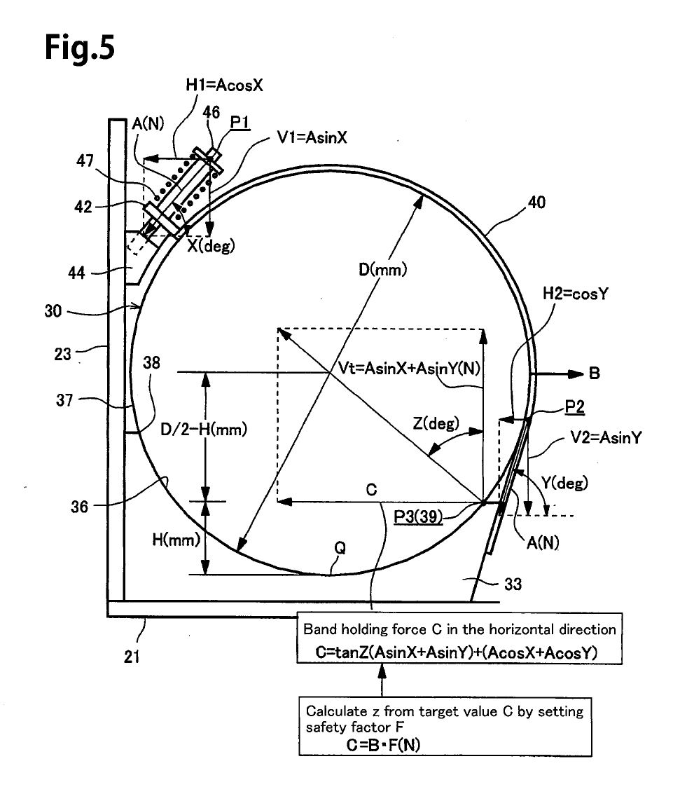

In the present embodiment, as shown in FIG. 5, the tank diameter of the hydrogen tank 30 is represented by “D” (mm).

The location where a spring load of the coil spring 47 on the bolt 46 acts is referred to as load point P1, and the location where a load acts on the end of the fixing band 40 closer to the weight is referred to as load point P2.

The front end 39 of the tank supporting surface 36 in the lower weight 33 is referred to as load point P3.

The height from the deepest point Q, which is the deepest part of the tank supporting surface 36, to the front end 39 of the tank supporting surface 36 is set as an end height H (mm).

A spring load of the coil spring 47 arranged on the bolt 46 is represented by A (N), and the external force that acts to force the hydrogen tank 30 toward the front is represented by B (N).

When the angle of the spring load A (N) relative to the horizontal direction at load point P1 is represented by X (deg), a fastening load applied by the fixing band 40 at the load point P2 is represented by A (N).

An angle of the fastening load A (N) of the fixing band 40 relative to the vertical direction at load point P2 is represented by Y (deg).

An angle of a direction in which a load acts relative to the vertical direction at load point P3 is represented by Z (deg).

With regard to the spring load A (N) at load point P1, a horizontal component H1 (N) and a vertical component V1 (N) are obtained as

V1=A sin X, H1=A cos X.

With regard to the fastening load A (N) of the fixing band 40 at load point P2, a horizontal component H2 (N) and a vertical component V2 (N) are obtained as

V2=A sin Y, H2=A cos Y.

Thus, a vertical component resultant force Vt (N) of the fastening force of the fixing band 40 is obtained as

Vt=A sin X+A sin Y.

A horizontal component resultant force Ht (N) of the fastening force of the fixing band 40 is obtained as

Ht=A cos X+A cos Y.

When a band holding force in the horizontal direction at load point P2 is represented by C (N), a value obtained by subtracting the horizontal component resultant force Ht from the band holding force C is a value that is the product of the vertical component resultant force Vt and tan Z. That is, the band holding force C is the sum of a value of the horizontal component resultant force Ht and a value of the product of the vertical component resultant force Vt and tan Z. Thus, the band holding force C is obtained as

C=tan Z·(A sin X+A sin Y)+(A cos X+A cos Y).

The expression is transposed to

tan Z=[C−(A cos X+A cos Y)]/(A sin X+A sin Y).

In the following description, an angle Z is obtained from the above expression using arctan (arc tangent). That is, the expression is transformed to

Z=arctan {[C−(A cos X+A cos Y)]/(A sin X+A sin Y)}.

With regard to the band holding force C, a target value is calculated by setting a sufficient safety factor F(multiple) for the expected external force B. That is, C is calculated by

C=B·F.

Thus, the value of the angle Z is obtained from the above arctan expression.

The end height H (mm) is obtained from the value of the calculated angle Z.

The tank radius is D/2 (mm). Thus, the value obtained by subtracting the product of the tank radius D/2 and cost from the tank radius D/2 is

H=D/2−D/2·cos Z.

A greater end height H would be more advantageous for withstanding external force. Thus, it is preferred that the end height H be set to be as great as possible under the limitations imposed by the space in the unit case 20.

From the calculation of the above expression, the end height H is set so that the band holding force C, which withstands the external force B (N) in the front-to-rear direction received by the hydrogen tank 30, limits separation of the hydrogen tank 30 from the tank supporting surface 36 (i.e., movement of the hydrogen tank 30 beyond the front end 39). The band holding force C is a force acting on the hydrogen tank 30 and generated by the fixing band 40.

The operation of the hydrogen tank fixing structure in the present embodiment will now be described.

The forklift 10 of the present embodiment does not include a suspension system. Thus, the hydrogen tank 30 may receive external force in the front-to-rear direction through vibration or impact when the forklift 10 is driven.

When external force acts on the hydrogen tank 30 from the front to the rear, even if the external force to the rear is large, the wall member 23 is located in the proximity of the rear of the hydrogen tank 30. Thus, the hydrogen tank 30 is not separated from the tank supporting surface 36.

When external force acts on the hydrogen tank 30 from the rear to the front, as shown in FIG. 5, the band holding force C does not separate the hydrogen tank 30 from the tank supporting surface 36 as long as the external force B is less than or equal to a fixed value.

The hydrogen tank fixing structure of the present embodiment has the advantages described below.

(1) The hydrogen tank 30 is supported by the tank supporting surface 36 of the weight member 32 in the fuel cell unit 19 and fixed by the fixing bands 40. Thus, since the hydrogen tank 30 is supported by the tank supporting surface 36 and fixed by the fixing bands 40, the impact resistance of the hydrogen tank 30 in the fuel cell unit 19 is improved.

(2) The hydrogen tank fixing structure is configured so that the hydrogen tank 30 is supported by the weight member 32, which adjusts weight in the unit case 20. The weight member 32 extends around and covers the hydrogen tank 30. This allows the space in the unit case 20, in particular, the space around the hydrogen tank 30, to be used effectively.

(3) The entire tank supporting surface 36 supports the outer circumferential surface 37 of the hydrogen tank 30. Thus, the concentration of load is avoided on the outer circumferential surface 37 of the hydrogen tank 30. This limits deformation of the hydrogen tank 30.

(4) The hydrogen tank 30 is able to withstand the external force B in cooperation with the fixing force of the fixing band 40 even when receiving the external force B in the front-to-rear direction that is less than or equal to a predetermined value. Thus, the external force B does not separate the hydrogen tank 30 from the tank supporting surface 36.

(5) The fixing band 40 is fixed between the front end 39 of the tank supporting surface 36 and the wall member 23. This shortens the fixing band 40.

The present invention is not limited to the above embodiment and may be modified in many other specific forms without departing from the spirit or scope of the invention. For example, the present invention may be modified as described below.

The above embodiment shows one example of a fuel cell forklift that serves as a fuel cell industrial vehicle. However, the above embodiment is not limited to a fuel cell forklift. In another example, the industrial vehicle may be a construction vehicle in addition to a lifting vehicle such as a forklift or a towing vehicle. It is only required that the industrial vehicle include a battery replacement fuel cell unit that is replaceable with a battery.

In the above embodiment, the hydrogen tank is held to the weight member by the two fixing bands. However, the number of fixing bands does not have to be two. For example, three fixing bands may be used. Alternatively, only one fixing band may be used when the band is sufficiently wide.

In the above embodiment, the weight member includes the upper weight and the lower weight. In another example, the weight member may include a single weight or three or more weights. In the unit case, the weight member does not have to be located at the rear and may be located at the front. The location of the weight member in the front, rear, left, and right directions may be set in accordance with the weight balance with other devices.

In the above embodiment, the hydrogen tank is supported by the tank supporting surface of the weight member. In another example, a rubber sheet may be arranged between the tank supporting surface and the outer circumferential surface of the hydrogen tank to prevent scratching and slipping of the outer circumferential surface of the hydrogen tank. Even when the rubber sheet is arranged, the tank supporting surface is shaped in conformance with the outer circumferential surface of the hydrogen tank when expanded.

### DESCRIPTION OF THE REFERENCE NUMERALS

10: forklift
11: vehicle body
12: lifting device
17: accommodation compartment
18: battery case
19: fuel cell unit
20: unit case
26: first device group
27: second device group
30: hydrogen tank
32: weight member
33: lower weight
34: upper weight
35: bolt
36: tank supporting surface
37: outer circumferential surface
38: rear end
39: front end
40: fixing band
42: connector
44: fixing member
46: bolt
47: coil spring
P1, P2, P3: load point
Q: deepest point
A: spring load, fastening load
B: external force
C: band holding force
D: tank diameter
F: safety factor
H1: horizontal component (P1)
H2: horizontal component (P2)
V1: vertical component (P1)
V2: vertical component (P2)
Ht: horizontal component resultant force
Vt: vertical component resultant force
X: angle (P1)
Y: angle (P2)
Z: angle (P3)

1. A hydrogen tank fixing structure for a fuel cell industrial vehicle, wherein:
a fuel cell unit that accommodates a fuel cell is accommodated in a battery accommodation compartment arranged in a vehicle body;
a weight member for weight adjustment and a hydrogen tank including a tubular cross-section are accommodated in the fuel cell unit;
an upper surface of the weight member forms a tank supporting surface that includes an arcuate cross-section and conforms to an outer circumferential surface of the hydrogen tank; and
the hydrogen tank is supported by the tank supporting surface and fixed by a fixing band extending in a circumferential direction of the outer circumferential surface of the hydrogen tank.

2. The hydrogen tank fixing structure for a fuel cell industrial vehicle according to claim 1, wherein the tank supporting surface is formed to conform to the outer circumferential surface of the hydrogen tank when the hydrogen tank expands.

3. The hydrogen tank fixing structure for a fuel cell industrial vehicle according to claim 1, wherein:
the tank supporting surface is set so that a radial direction of the hydrogen tank conforms to a front-to-rear direction of the vehicle body;
the fuel cell unit includes a wall member arranged proximal to a first end of the tank supporting surface in the weight member;
a second end of the tank supporting surface has an end height set from a deepest point, which is deepest in the tank supporting surface, to the second end of the tank supporting surface; and
the end height is set so that when external force in the front-to-rear direction received by the hydrogen tank is less than or equal to a predetermined value, the end height cooperates with a band holding force of the fixing band to avoid a situation in which the hydrogen tank that receives the external force is separated from the tank supporting surface.

4. The hydrogen tank fixing structure for a fuel cell industrial vehicle according to claim 3, wherein:
the fixing band includes a weight side end, which is fixed to the second end of the tank supporting surface in the weight member, and a wall side end, which is fixed to the wall member; and
the weight side end or the wall side end is removable.

5. A hydrogen tank fixing structure for fixing a hydrogen tank including a tubular cross-section for a fuel cell industrial vehicle, wherein a vehicle body of the fuel cell industrial vehicle includes an accommodation compartment for a battery, and the accommodation compartment receives a fuel cell unit that accommodates a fuel cell and the hydrogen tank, the hydrogen tank fixing structure comprising:
a weight member for weight adjustment accommodated in the fuel cell unit;
a tank supporting surface including an arcuate cross-section and formed by an upper surface of the weight member in conformance with an outer circumferential surface of the hydrogen tank, wherein the tank supporting surface supports the hydrogen tank; and
a fixing band extended in a circumferential direction of the outer circumferential surface of the hydrogen tank, wherein the hydrogen tank is fixed by the fixing band.

6. A fuel cell unit including a hydrogen tank fixing structure for a fuel cell industrial vehicle, wherein the fuel cell unit is accommodated in a battery accommodation compartment arranged in a vehicle body of the fuel cell industrial vehicle, the fuel cell unit comprising:
an internally accommodated hydrogen tank including a tubular cross-section;
an internally accommodated fuel cell;
an internally accommodated weight member for weight adjustment;
a tank supporting surface including an arcuate cross-section and formed by an upper surface of the weight member in conformance with an outer circumferential surface of the hydrogen tank, wherein the tank supporting surface supports the hydrogen tank; and
a fixing band extended in a circumferential direction of the outer circumferential surface of the hydrogen tank, wherein the hydrogen tank is fixed by the fixing band.
